(19) United States
(12) Patent Application Publication
(10) Pub. No.: US 2011/0149457 A1
(43) Pub. Date: Jun. 23, 2011

(54) ELECTRONIC TRIGGERING UNIT FOR AN ELECTROMAGNETICALLY ACTUATED VALVE FOR OPERATING A HYDROSTATIC DISPLACEMENT UNIT

(76) Inventors: Alejandro Lopez Pamplona, Horb (DE); Bjoern Beuter, Hirrlingen (DE)

(21) Appl. No.: 12/958,989

(22) Filed: Dec. 2, 2010

(30) Foreign Application Priority Data
Dec. 3, 2009 (DE) 10 2009 056 802.6

(51) Int. Cl. H01F 7/18; H01H 47/22

(52) U.S. Cl. 361/156

(57) ABSTRACT

An electronic triggering unit for an electromagnetically actuated valve is disclosed, in which the valve is provided in particular for a hydrostatic displacement unit. The electronic triggering unit has a first switching device, which during the attraction phase of the valve applies a first voltage to its coil, which voltage is higher than the operating voltage of the electronic triggering unit. This first voltage is obtained from the operating voltage by means of a voltage-increasing circuit. A second switching device, during the maintenance phase of the valve, applies a second voltage, which corresponds approximately to the operating voltage, to its coil. According to the invention, the voltage-increasing circuit is a booster circuit, which in response to a corresponding trigger signal charges a buffer memory to the increased first voltage.

### CROSS-REFERENCE TO RELATED APPLICATION

This application is based on German Patent Application 10 2009 056 802.6 filed on Dec. 3, 2009.

### BACKGROUND OF THE INVENTION

1. Field of the Invention

The present invention relates to the electronic triggering unit for an electromagnetically actuated valve, which is provided in particular for operating a hydrostatic displacement unit. The hydrostatic displacement unit of the invention may for instance be hydromachine.

2. Description of the Prior Art

Such valve-controlled hydromachines are known for instance from European Patent Disclosure EP 1 537 333 B1. This reference shows a hydromachine of the axial or radial piston type, which in principle can be operated as a motor or as a pump, and the displacement volume or absorption volume is continuously variably adjustable via the valve controller. In a described exemplary embodiment, the hydromachine is embodied as an axial piston engine, in which a plurality of pistons disposed in a cylinder is braced on a rotatably supported swash plate. Each piston, with the associated cylinder chamber, defines a work chamber, which via a low-pressure side valve and a high-pressure side valve can be made to communicate with a pressure fluid inlet or a pressure fluid outlet.

From the above-explained construction of such hydromachines, it becomes clear that for their triggering, a plurality of electromagnetically actuated valves is needed. To ensure the most uniform possible triggering of these many valves, which is indispensible for clean operation of the hydromachine, stringent demands are made of the electromagnetically actuated valves and their electronic triggering unit. The requisite high-precision chronological tuning of the triggering of the individual valves, however, can be achieved only if the switch-on speed of the valves is as high as possible, or their switch-on delay is as slight as possible. Switching off the valves, too, should proceed as fast as possible.

The switch-on speed of an electromagnetic valve, however, is limited to a value which results from the trigger voltage in conjunction with the electrical parameters of the coil, or in other words its inductive resistance L and its ohmic resistance R, and the switching speed is higher, the lower the factor L/R. Similarly, the shutoff speed of the valve is limited primarily by these electrical parameters, even if the shutoff of the valve is done by pole reversal.

The switching speed can thus in principle be increased by a structural change in the coil of the valve, by reducing the factor L/R (“faster” coil). In practice, however, this kind of structural change of the coil is often not possible for many reasons, so that as a rule it is not used as a means for increasing the switching speed.

In International Patent Disclosure WO 01/61156 A1, a circuit arrangement is described for triggering solenoids which are provided for camshaft-free actuation of the gas exchange valves of an internal combustion engine. An internal combustion engine equipped with such gas exchange valves can normally be operated in a stable fashion only if the triggering of the solenoids is done by means of regulation. Because of the number of valves—in modern 4-cylinder engines, 32 valves are already needed—such regulation is, however, associated with very major complexity in terms of circuitry, especially since correspondingly many sensors are needed for the feedback of the regulation parameters.

In WO 01/61156 A1, it is proposed that this high complexity of circuitry be reduced by furnishing two stabilized voltages; the first voltage, which is substantially higher than the on-board voltage of the vehicle, is applied during the attraction phase of the solenoid, while the second, markedly lower voltage is applied during the maintenance phase of the solenoid. This type of triggering is based on the recognition that the valve attraction phase, which from a regulation standpoint is already difficult to control, becomes shorter because of the increased first voltage.

If the triggering principle known from WO 01/61156 A1 were to be used for the problems on which the invention is based, namely for operating a hydromachine, then in fact the problem discussed at the outset of increasing the switch-on speed of the solenoid could in fact be solved without having to change the electrical parameters of its coil. However, a further problem in operating hydromachines is that their individual chambers have to be triggered very nonuniformly as a function of the particular mode of operation, so that individual solenoids are open or closed for a very long time, while others at the same time have a markedly higher switching frequency.

However, the electronic stabilization of the two voltages must be designed such that even with simultaneous triggering of all the solenoids, no voltage dip occurs. The dimensioning of the stabilizing circuits must therefore be selected such that even in the state of operation of simultaneous triggering of all the solenoids, they furnish a stable voltage. The total efficiency of the electronic triggering unit is reduced as a result, and the heat development in it increases accordingly. In particular, the first voltage is constantly present. However, since in practice the percentage of this operating state is relatively low, the stabilizing circuits would predominantly operate in a range of low load, where their energy efficiency is known by experience to be low.

### OBJECT AND SUMMARY OF THE INVENTION

It is the object of the invention to refine the electronic triggering unit for an electromagnetically actuated valve for a hydrostatic displacement unit, in particular such as a hydromachine, in such a way that the switching speed of the solenoids can be improved, while maintaining the structural freedom for the solenoids and simultaneously attaining high efficiency.

Thus in agreement with the teaching of WO 01/61156 A1, the invention contemplates shortening the attraction phase of the solenoid by applying a voltage which is higher than the actual operating voltage of the electronic unit. However, turning away from the teaching of this reference, the present invention proposes furnishing the increased voltage by means of a booster circuit, which in response to a corresponding trigger signal charges a buffer memory to the increased voltage. Since the storage capacity of the buffer memory, in accordance with the invention, is preferably dimensioned such that the increased voltage is available solely for at least the duration of the attraction phase, the energy consumption of the booster circuit is very low, and especially including in the above-explained operating state in which individual solenoids are open or closed for a very long time. Thus with the invention, a marked increase in the switching speed of the solenoids can be attained, without at the same time increasing the energy consumption significantly, so that the total efficiency of a hydromachine operated with the electronic triggering unit remains very high.

The invention is thus distinguished not only by a fast and precisely controllable attraction phase but also by high energy efficiency and a correspondingly low heat development in the electronic triggering unit.

To ensure that the increased voltage is always available for the attraction phase, it is provided in a refinement of the invention that the trigger signal for activating the booster circuit is generated after the electronic triggering unit is switched on and after the termination of each attraction phase.

The efficiency can be further improved by providing that the current, flowing into the coil of the valve upon shutoff of the valve, is fed back via a switching device, preferably in the form of a diode, into the buffer memory, preferably embodied as a capacitor, of the booster circuit and is stored there. This provision has the additional advantage that the shutoff of the solenoid as well takes place faster, because of the increased shutoff voltage.

### BRIEF DESCRIPTION OF THE DRAWINGS

The invention will be better understood and further objects and advantages thereof will become more apparent from the ensuing detailed description of a preferred embodiment taken in conjunction with the drawings, in which:

FIG. 1 shows a schematic circuit diagram of one embodiment of the electronic triggering unit of the invention; and

FIG. 2 is a graph of characteristic curves of the particular voltage value of the coil of a solenoid used for the invention, at two different voltages.

### DESCRIPTION OF THE PREFERRED EMBODIMENT

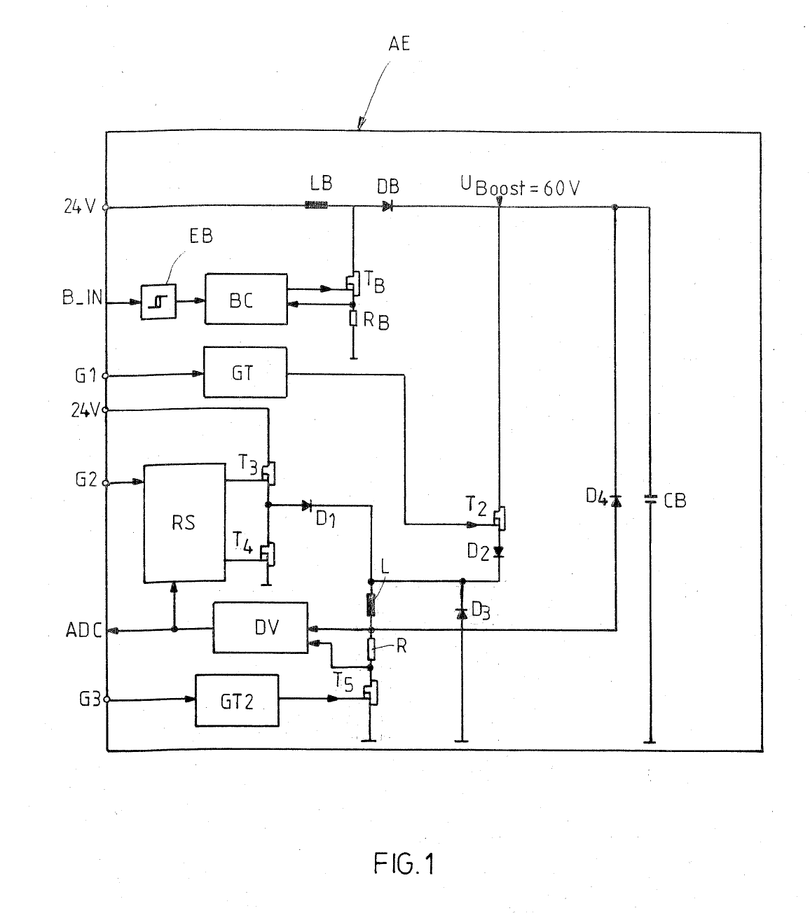

First, the basic layout of an electronic triggering unit of the invention, schematically indicated by AE, will be explained below in conjunction with FIG. 1. The schematic circuit diagram shows only that part of the circuit that is intended for triggering a single solenoid; in practice, many of these circuit elements are necessary for operating a hydromachine, and these circuit elements, along with the higher-order control unit, which furnishes the external trigger signals shown in FIG. 1, are preferably embodied in the form of a single electronic module.

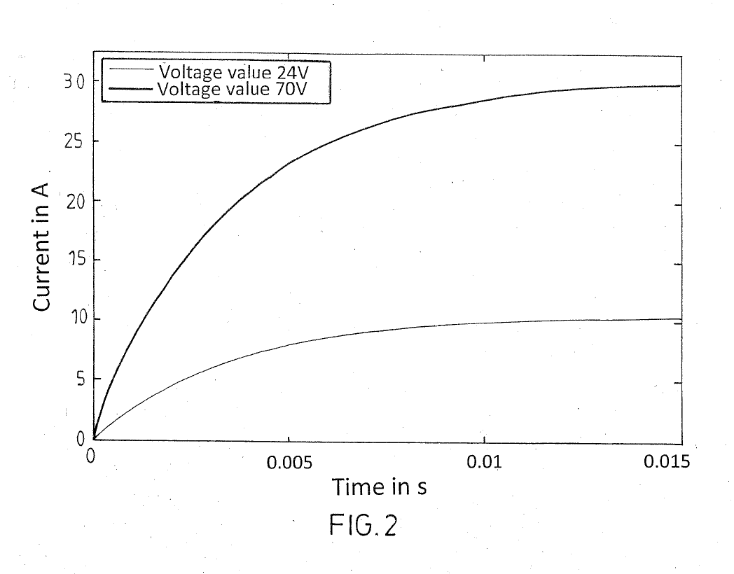

In FIG. 1, the electronic triggering unit AE triggers the coil L of a solenoid (not shown in detail). In practice the coil L has an inductance with the value of 8 mH, and an ohmic resistor R has the value of 2.3 Ohms. In this case, the voltage values shown in FIG. 2 result upon the application of an input voltage of 24V and an input voltage of 70V, respectively. From the comparison of these two characteristic curves, it becomes clear that the higher voltage of 70V causes a substantially faster, stronger increase in the current through the coil; accordingly, the solenoid switches correspondingly faster at the increased voltage.

The coil L is connected to ground on its end toward ground via a measuring resistor R and a field effect transistor T5, which is switched on and off by means of an external trigger signal G3 via a gate trigger circuit GT2. A differential amplifier DV detects the voltage drop, applied via the measuring resistor R, and carries the corresponding measured value, which is also conducted to the outside as a signal ADC, to a regulating amplifier RS, which, taking into account an external set-point signal G2, triggers two field effect transistors T3 and T4 in such a way that the voltage, supplied via a diode D1 to the end toward the supply voltage of the coil L corresponds to the desired set-point value. The regulating amplifier RS therefore, together with the field effect transistors T3 and T4, the diode D1, the measuring resistor R, and the differential amplifier DV, forms a switching device, which supplies the coil L with a voltage corresponding approximately to the operating voltage or supply voltage of the electronic triggering unit AE. In the exemplary embodiment, this operating voltage is 24V, and it supplies the coil L with current during the maintenance phase.

In FIG. 1, another switching device is provided, which is formed of a field effect transistor T2, a diode D2, which connects the output toward ground of the field effect transistor T2 to the end toward the supply voltage of the coil L, and a gate trigger circuit GT, which triggers the gate of the field effect transistor T2 on the specification of a trigger signal G1. On the input side, a voltage U_BOOST is applied to the field effect transistor T2; in the exemplary embodiment, this voltage amounts to 60V and is furnished by a capacitor CB.

This first switching device serves to subject the coil L of the solenoid, during its attraction phase, to the voltage of 60V, which is markedly increased over the operating voltage.

The voltage of 60V increased compared to the operating voltage is generated according to the invention by a booster circuit, which in response to a corresponding trigger signal or booster signal B_IN generates an output voltage of 60V, over a predetermined period of time, from the operating voltage; this output voltage charges the capacitor CB, acting as a buffer memory, with a charge quantity that is dimensioned such that during the attraction phase, the coil L can be supplied with sufficient current or sufficient energy.

The booster circuit generates the increased voltage by means of a resonant circuit comprising a booster coil LB and a booster resistor RB; this resonant circuit, by suitable triggering of a booster transistor TB via a booster controller BC triggered by a booster input stage EB, generates voltage peaks, which charge the capacitor CB via a booster diode DB. The booster signal B_IN, which causes the charging of the capacitor CB, is present at the booster input stage EB.

Finally, besides a freewheel diode D3, which guards the field effect transistor T5 from voltage peaks upon shutoff, the electronic triggering unit AE also has a diode D4, which connects the end toward ground of the coil L to the voltage-carrying end of the capacitor CB. Because of this interconnection, the diode D4 forms a switching device which upon shutoff of the coil L conducts its shutoff current into the capacitor CB. As a result of this provision, not only is the speed of shutoff of the coil, which now takes place compared to the increased boost voltage, markedly increased, but the favorable additional effect is also attained that the capacitor CB is correspondingly recharged. This produces a not inconsiderable energy saving.

The electronic triggering unit of the invention functions as follows:

When the booster signal B_IN is delivered to the booster input stage EB, the booster circuit, over a period of time predetermined by the duration of the booster signal B_IN, generates the increased voltage of 60V, which is applied to the capacitor CB and charges it accordingly. The current course of the circuit during this phase of operation is indicated in FIG. 1 by the current path.

When the first switching device is activated by the application of the trigger signal G1, the field effect transistor T2 is made conducting, so that the coil L is acted upon by the voltage, present at the capacitor CB, of 60V. During this phase of operation, which represents the attraction phase of the solenoid, the current course in the circuit is as indicated in FIG. 1 by the current path. During this attraction phase, the capacitor CB discharges, with a time constant that is predetermined by its capacitance.

The end of the attraction phase is initiated by the termination of the signal G1, as a result of which the field effect transistor T2 switches off, so that the coil is no longer acted upon by the high voltage of 60V. Approximately at the same time, by application of the signal G2, the roger RS is activated, which during this maintenance phase, via the field effect transistors T3 and T4, supplies the coil with a regulated voltage; this is approximately equivalent to the operating voltage. During this maintenance phase of the valve L the current has the course in the circuit as indicated by the current path in FIG. 1.

Both during the attraction phase and during the maintenance phase, the signal G3 is also present at the circuit and activates the field effect transistor T5, so that the other end of the coil is connected to ground, and the two current paths can develop.

Whenever both the trigger signal G2 and the trigger signal G3 are then terminated, the shutoff phase of the valve L is initiated; during this shutoff phase, the current flows through the diode D4, along the path in FIG. 1, back into the capacitor CB, so that the capacitor is recharged, at least partially.

To ensure that the valve, at all times, can be put back into a subsequent attraction phase, the booster circuit is put back into operation, preferably immediately after the end of each attraction phase, by the supply of the booster signal B_IN, so that the capacitor CB is recharged.

If the coil L is in the maintenance phase or the shutoff phase over a relatively long period of time, it is possible for possible self-discharging of the capacitor CB to be compensated for by providing that the booster circuit is activated at suitable regular time intervals, so that it is ensured that the energy stored in the capacitor will never drop below a predetermined value. The next attraction phase can thus be initiated at all times at the desired high voltage.

The invention is distinguished by means of the booster circuit not only in that the attraction phase can be shortened without structural change to the coil L. Alternatively, it would also be possible to increase the factor L/R of the coil for any other reasons and nevertheless maintain the desired set-point time of the attraction phase.

Finally, a major advantage of the invention is that the improvement in the attraction phase is attainable at relatively little effort and expense for circuitry and without significant lessening of the overall efficiency.

The foregoing relates to a preferred exemplary embodiment of the invention, it being understood that other variants and embodiments thereof are possible within the spirit and scope of the invention, the latter being defined by the appended claims.

1. A electronic triggering unit for an electromagnetically actuated valve, in which the valve is provided in particular for a hydrostatic displacement unit, the electronic triggering unit comprising:
a first switching device, which during an attraction phase of the valve applies a first voltage to its coil, which voltage is higher than an operating voltage of the electronic triggering unit;
a voltage-increasing circuit, which generates the first voltage from the operating voltage, and
a second switching device, which during a maintenance phase of the valve applies a second voltage to its coil;
wherein the voltage-increasing circuit is a booster circuit, which in response to a corresponding trigger signal charges a buffer memory to the increased first voltage.

2. The electronic triggering unit as defined by claim 1, wherein the storage capacity of the buffer memory is dimensioned such that the increased first voltage is available for at least duration of the attraction phase.

3. The electronic triggering unit as defined by claim 1, wherein the buffer memory is a capacitor.

4. The electronic triggering unit as defined by claim 2, wherein the buffer memory is a capacitor.

5. The electronic triggering unit as defined by claim 1, wherein the trigger signal for activating the booster circuit is generated after the electronic triggering unit is switched on and after termination of each attraction phase.

6. The electronic triggering unit as defined by claim 2, wherein the trigger signal for activating the booster circuit is generated after the electronic triggering unit is switched on and after termination of each attraction phase.

7. The electronic triggering unit as defined by claim 3, wherein the trigger signal for activating the booster circuit is generated after the electronic triggering unit is switched on and after termination of each attraction phase.

8. The electronic triggering unit as defined by claim 4, wherein the trigger signal for activating the booster circuit is generated after the electronic triggering unit is switched on and after termination of each attraction phase.

9. The electronic triggering unit as defined by claim 5, wherein the trigger signal for activating the booster circuit is additionally always generated whenever electrical energy stored in the capacitor drops below a predetermined value.

10. The electronic triggering unit as defined by claim 6, wherein the trigger signal for activating the booster circuit is additionally always generated whenever electrical energy stored in the capacitor drops below a predetermined value.

11. The electronic triggering unit as defined by claim 7, wherein the trigger signal for activating the booster circuit is additionally always generated whenever electrical energy stored in the capacitor drops below a predetermined value.

12. The electronic triggering unit as defined by claim 8, wherein the trigger signal for activating the booster circuit is additionally always generated whenever electrical energy stored in the capacitor drops below a predetermined value.

13. The electronic triggering unit as defined by claim 3, further comprising a switching device, which conducts current, flowing upon shutoff of the valve into its coil, into the capacitor and stores the current there.

14. The electronic triggering unit as defined by claim 5, further comprising a switching device, which conducts current, flowing upon shutoff of the valve into its coil, into the capacitor and stores the current there.

15. The electronic triggering unit as defined by claim 9, further comprising a switching device, which conducts current, flowing upon shutoff of the valve into its coil, into the capacitor and stores the current there.

16. The electronic triggering unit as defined by claim 13, wherein the switching device is a diode.

17. The electronic triggering unit as defined by claim 14, wherein the switching device is a diode.

18. The electronic triggering unit as defined by claim 15, wherein the switching device is a diode.

19. The electronic triggering unit as defined by claim 1, wherein the second switching device includes a roger, which during the maintenance phase of the valve adjusts the current flowing through its coil.

20. The electronic triggering unit as defined by claim 1, wherein the second voltage is approximately equivalent to the operating voltage.
